(19) United States
(12) Patent Application Publication
(10) Pub. No.: US 2009/0303391 A1
(43) Pub. Date: Dec. 10, 2009

(54) DISPLAY APPARATUS AND CONTROL METHOD OF THE SAME

(75) Inventors: Jun-ho JUNG, Seoul (KR); Han-feng CHEN, Suwon-si (KR); Jun-ho SUNG, Seoul (KR); Tae-hyeun HA, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/353,521

(22) Filed: Jan. 14, 2009

(30) Foreign Application Priority Data
Jun. 9, 2008 (KR) 10-2008-0053787

(51) Int. Cl. H04N 5/57

(52) U.S. Cl. 348/687; 348/E05.119

(57) ABSTRACT

A display apparatus includes: a display unit which displays an image; and a signal controller which determines a motion state of a current frame on the basis of a previous frame and the current frame input in sequence, generates a first sub-frame of which brightness is varied according to the motion state of the current frame, generates at least one second sub-frame to compensate the brightness of the first sub-frame on the basis of the first sub-frame and the current frame, and controls the first sub-frame and the second sub-frame to be displayed on the display unit in sequence.

### CROSS-REFERENCE TO RELATED APPLICATION

This application claims priority from Korean Patent Application No. 10-2008-0053787, filed on Jun. 9, 2008 in the Korean Intellectual Property Office, the disclosure of which is incorporated herein by reference.

### BACKGROUND OF THE INVENTION

1. Field of Invention

Apparatuses and methods consistent with the present invention relate to a display apparatus and a control method of the same, and more particularly to a hold-type display apparatus and a control method of the same.

2. Description of the Related Art

A display apparatus may be classified into a hold type where an image is successively displayed during one frame and an impulsive type where an image is displayed only for a short time of scanning a video signal within one frame. As an example of the impulsive-type display apparatus, there is a cathode ray tube (CRT). On the other hand, a liquid crystal display (LCD) having a liquid crystal layer, and an organic light emitting display (OLED) having an organic light emitting diode are examples of the hold-type display apparatus.

Such a hold-type display apparatus induces an image blurring phenomenon or a motion blur that does not occur in the impulsive-type display apparatus. The image blurring phenomenon more frequently appears as a displayed image approximates to a motion picture. Further, the image blurring phenomenon becomes more prominent as the size of the display apparatus increases since it should be driven more quickly in proportion to the size thereof

To prevent the image blurring phenomenon, the motion blur or the like residual image, there has been used a driving method of inserting a black screen. Such a driving method reduces the image blurring phenomenon that occurs in the display apparatus, but the black screen causes the brightness of an image to be decreased and a flicker to be generated due to difference in the brightness between neighboring frames.

### SUMMARY OF THE INVENTION

Accordingly, it is an aspect of the present invention to provide a display apparatus and a control method of the same, in which a motion blur and a flicker are decreased.

Another aspect of the present invention is to provide a display apparatus and a control method thereof, in which brightness is enhanced.

Still another aspect of the present invention is to provide a display apparatus capable of adjusting an additional image inserted according to motion in an image, and a control method of the same.

The foregoing and/or other aspects of the present invention can be achieved by providing a display apparatus including: a display unit which displays an image; and a signal controller which determines a motion state of a current frame on the basis of a previous frame and the current frame input in sequence, generates a first sub-frame of which brightness is varied according to the motion state of the current frame, generates at least one second sub-frame to compensate the brightness of the first sub-frame on the basis of the firs sub-frame and the current frame, and controls the first sub-frame and the second sub-frame to be displayed on the display unit in sequence.

The signal controller may generate a motion coefficient representing the motion state of the current frame and a smoothing frame obtained by removing a high frequency from the current frame, and generates the first sub-frame by synthesizing the motion coefficient and the smoothing frame.

The motion coefficient may have a value that ranges from 0 to 1, and becomes lower as the motion state of the current frame increases.

The signal controller may determine whether the current frame contains a motion, and the motion coefficient of the current frame is set by subtracting a preset constant from the motion coefficient of the previous frame if the current frame contains the motion.

The signal controller may determine whether the current frame contains a motion, and the motion coefficient of the current frame is set by adding a preset constant to the motion coefficient of the previous frame if the current frame contains no motion.

The smoothing frame may include average brightness of the current frame.

The signal controller may divide the current frame into a plurality of image blocks, and calculates average brightness of each divided image block, and the smoothing frame may be formed on the basis of the image block.

The signal controller may reduce difference in brightness between neighboring video signals corresponding to boundaries of the image blocks.

The signal controller may set the brightness of the video signals corresponding to the boundaries of the image blocks as the average brightness between the neighboring video signals.

The signal controller may remove a high-frequency image from the boundaries of the image blocks.

The brightness of the second sub-frame may correspond a value obtained by subtracting the brightness of the first sub-frame from doubled brightness of the current frame.

The signal controller may generate an additional smoothing frame based on the second sub-frame, and generates a third sub-frame based on the additional smoothing frame and the motion coefficient.

The signal controller may generate a fourth sub-frame corresponding to a value obtained by subtracting the brightness of the first sub-frame from doubled brightness of the third sub-frame.

The signal controller may display at least two sub-frames among the first, second, third and fourth sub-frames for a preset period of time in sequence.

The display unit may include either of a liquid crystal panel or an organic light emitting display panel.

The foregoing and/or other aspects of the present invention can be achieved by providing a method of controlling a display apparatus including: determining a motion state of a current frame on the basis of a previous frame and the current frame input in sequence; generating a first sub-frame of which brightness is varied according to the motion state of the current frame; generating at least one second sub-frame to compensate the brightness of the first sub-frame on the basis of the firs sub-frame and the current frame; and controlling the first sub-frame and the second sub-frame to be displayed in sequence.

The determining the motion state may include: determining whether the current frame contains a motion; and calculating a motion coefficient that represents the motion state of the current frame.

The motion coefficient may have a value that ranges from 0 to 1, and becomes lower as the motion state of the current frame increases.

The motion coefficient of the current frame may be set by subtracting a preset constant from the motion coefficient of the previous frame if the current frame contains a motion.

The motion coefficient of the current frame may be set by adding a preset constant to the motion coefficient of the previous frame if the current frame contains no motion.

The generating the first sub-frame may include: generating a smoothing frame by removing a high frequency from the current frame; and synthesizing the motion coefficient and the smoothing frame.

The generating the smoothing frame may include: dividing the current frame into a plurality of image blocks; and calculating average brightness of each divided image block.

The generating the first sub-frame may include: reducing difference in brightness between neighboring video signals corresponding to boundaries of the image blocks.

The generating the second sub-frame may include: doubling the brightness of the current frame; and subtracting the brightness of the first sub-frame from the doubled brightness of the current frame.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of a display apparatus according to a first embodiment of the present invention;

FIG. 2 is a control block diagram of a signal controller in FIG. 1;

FIGS. 3A through 3C are views for explaining a method of processing a video signal through a smoothing module in FIG. 2;

FIGS. 4A through 4D are graphs for explaining a method of processing a video signal in the signal controller in FIG. 2;

FIGS. 5A and 5B are graphs for explaining an effect of the first embodiment on brightness of a video signal;

FIG. 6 is a flowchart of controlling the display apparatus according to the first embodiment;

FIG. 7 is a control block diagram of a signal controller according to a second embodiment of the present invention; and

FIG. 8 illustrates frames according to FIG. 7.

### DETAILED DESCRIPTION OF THE INVENTION

Below, embodiments of the present invention will be described in detail with reference to accompanying drawings so as to be easily realized by a person having ordinary knowledge in the art. The present invention may be embodied in various forms without being limited to the embodiments set forth herein. Descriptions of well-known parts are omitted for clarity, and like reference numerals refer to like elements throughout.

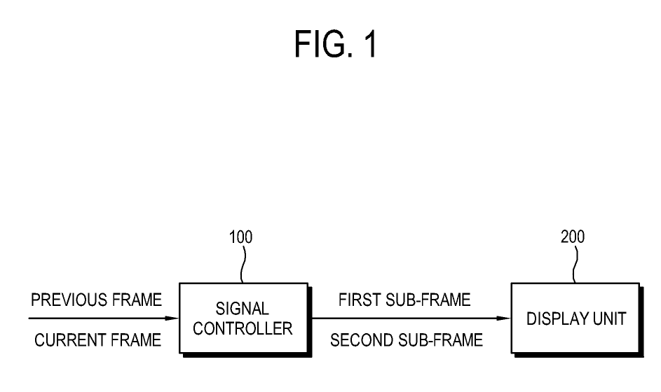

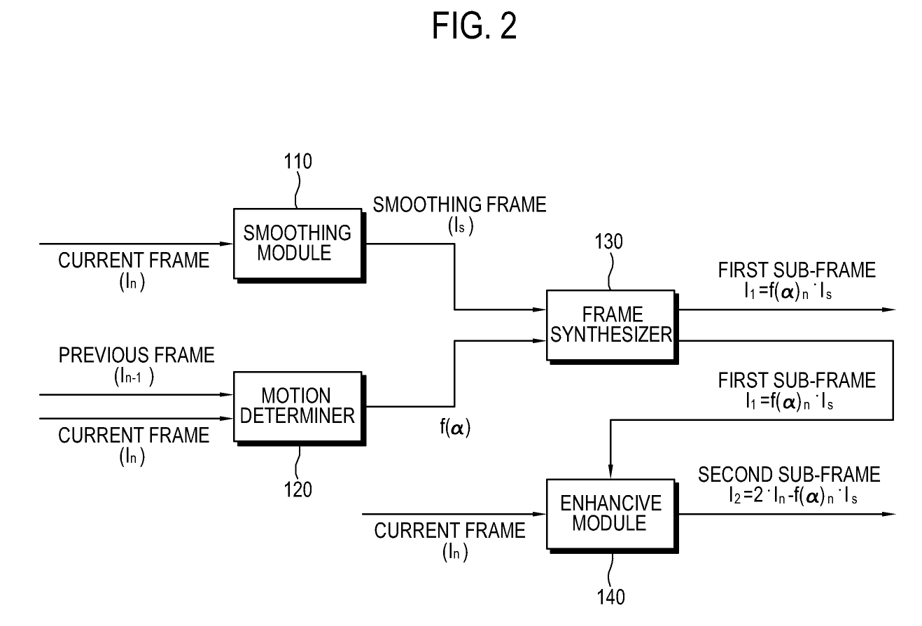

FIG. 1 is a control block diagram of a display apparatus according to a first embodiment of the present invention, and FIG. 2 is a detailed control block diagram of a signal controller of FIG. 1.

As shown therein, a display unit 200 may include a liquid crystal display (LCD) panel including a liquid crystal layer, or an organic light emitting display (OLED) panel including an organic light emitting diode. The LCD panel or the OLED panel gives the display apparatus a hold-type characteristic of displaying a continuous image during one frame. In the case of the hold-type display apparatus, a video signal is maintained for a predetermined time if once it is input. Thus, the hold-type display apparatus is easier to have problems of an image blurring phenomenon and a residual image than an impulsive-type display apparatus.

The signal controller 100 determines motion in a current frame on the basis of previous and current frames that are successively input, and generates a plurality of sub-frames according to the motion in the current frame. Further, the signal controller 100 outputs the generated sub-frames to a display unit 200 in sequence for a predetermined time. Generally, the frame refers to an image displayed on the display unit 200 during one unit time. In this embodiment, the frame refers to a displayed image or a video signal for the displayed image.

The signal controller 100 generates a first sub-frame changed in brightness according to the motion in the current frame, and at least one second sub-frame for compensating the brightness of the first sub-frame on the basis of the current frame. In this embodiment, the signal controller 100 displays two sub-frames for a period of time when one frame was displayed conventionally. In the case of the hold-type display apparatus or the like, the higher a frame frequency increases, the more the image blurring phenomenon is prevented and the more a motion picture is improved in visibility. Instead of one current frame input by the signal controller 100, two sub-frames are output so that the frame frequency increases two times higher than that of an input image. Alternatively, the signal controller 100 may generate three or more sub-frames, and in this case the frame frequency further increases.

As shown in FIG. 2, the signal controller 100 includes a smoothing module 110, a motion determiner 120, a frame synthesizer 130 and an enhancive module 140. The signal controller 100 controls the frame synthesizer 130 to generate a first sub-frame I₁ on the basis of a smoothing frame Iₛ generated in the smoothing module 110 and a motion coefficient f (α), and controls the enhancive module 140 to generate a second sub-frame I₂ on the basis of the first sub-frame I₁ and a current frame Iₙ. The signal controller 100 may be achieved by an analog circuit, an integrated circuit or the like, which can serve as the foregoing elements.

The smoothing module 110 generates a smoothing frame Iₛ obtained by removing a high-frequency image from the current frame Iₙ. Generally, the high-frequency image refers to a video signal of which brightness difference from neighboring video signal is very high. That the high-frequency image is adjusted to have a video signal having a low brightness difference from neighboring video signal is represented as the high frequency image is removed, and the smoothing module 110 performs this operation. The smoothing module 110 may include a low-pass filter, and an image processing method of using the low-pass filter to remove the high frequency may be realized by various known methods.

According to another embodiment of the present invention, the smoothing module 110 may generate the smoothing frame Iₛ through diverse algorithms and interpolation methods. The brightness of the smoothing frame Iₛ may be set as one certain value like the maximum brightness, the minimum brightness, an intermediate brightness, or an average brightness of the current frame Iₙ. If the smoothing frame Iₛ has the average brightness of the current frame Iₙ, the smoothing module 110 divides the input video signal according to colors, and calculates an average brightness with regard to each color, thereby forming the smoothing frame Iₛ based on the average brightness. In more detail, the smoothing module 110 calculates the average brightness of the video signal for red in the current frame Iₙ, the average brightness of the video signal for green, and the average brightness of the video signal for blue, respectively. Then, the red, green and blue video signals each having the average brightness are synthesized to form the smoothing frame Iₛ.

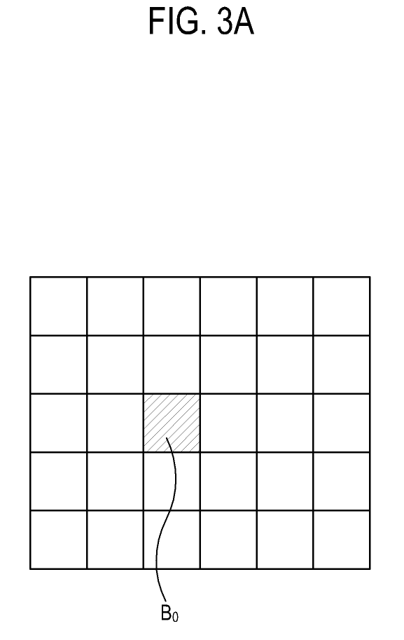

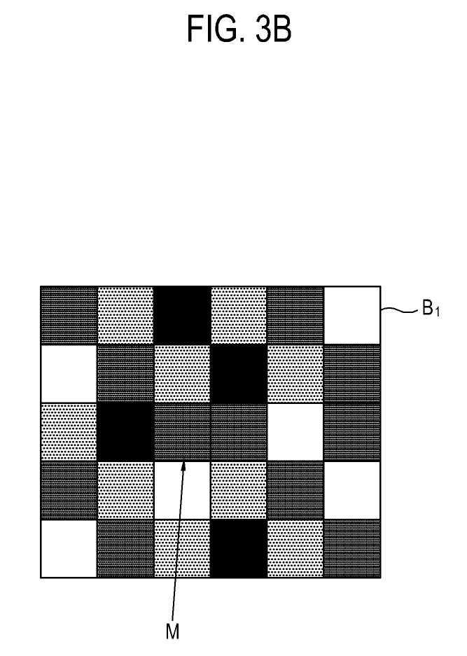

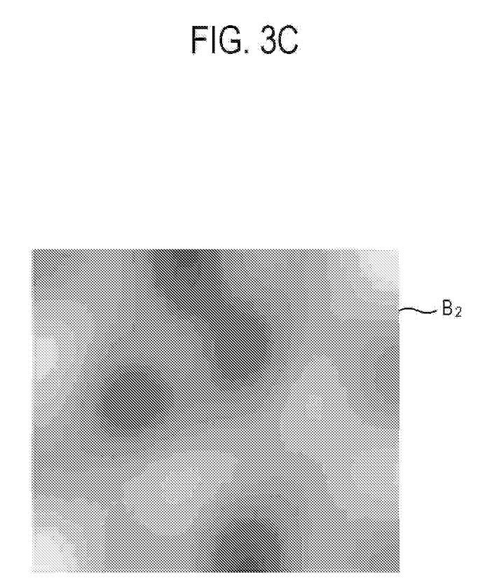

FIGS. 3A through 3C are views for explaining a method of processing a video signal through the smoothing module 110. The smoothing module 110 divides the input current frame Iₙ into a plurality of image blocks, and calculates the average brightness of each image block. FIG. 3A illustrates that the current frame Iₙ is divided into a matrix-shaped image block B₀, and FIG. 3B illustrates the average brightness of the divided image block B₀. FIG. 3B shows a sub-frame B₁ having the average brightness calculated corresponding to each image block B₀, in which each image block of the sub-frame B₁ has the average brightness different each other according to the image blocks B₀. In other words, the image blocks of which average brightness is relatively high and the image blocks of which average brightness is relatively low are being mixed. This case is more advantageous to fully reflect the original brightness of the current frame Iₙ in the first sub-frame I₁ than that the foregoing certain value or the average brightness is used to form the smoothing frame Iₛ.

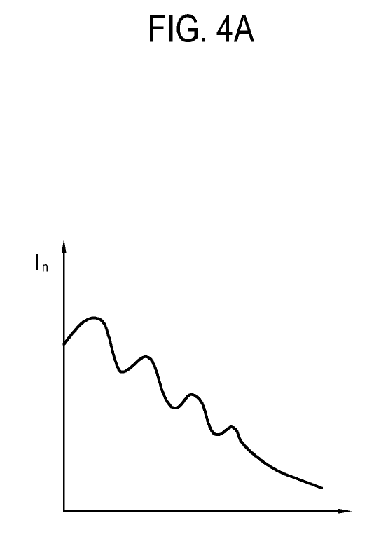

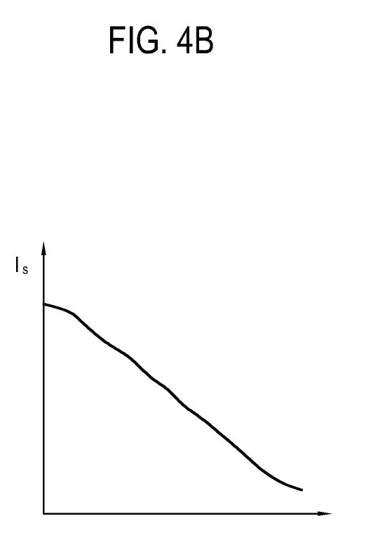

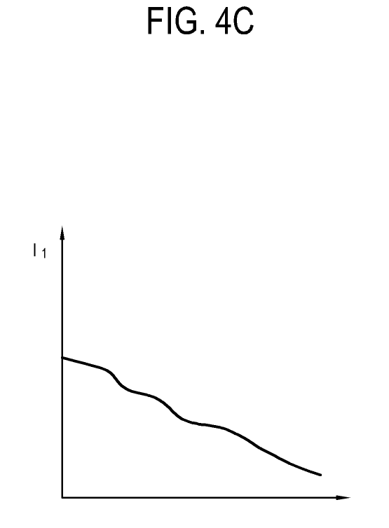

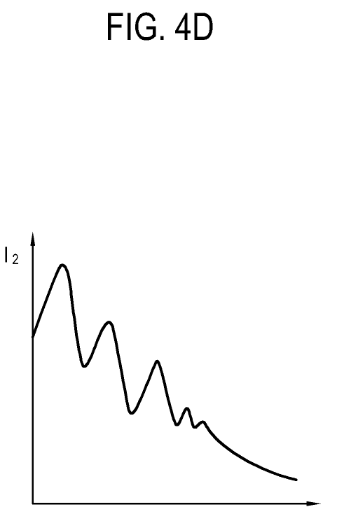

FIGS. 4A through 4D show the brightness of the frame images according to operations of processing the video signal in the signal controller 100. Here, each graph expresses the brightness of a two-dimensional frame image as one-dimensional one, in which an X-axis indicates a certain part of an input image. Otherwise, the X-axis may correspond to time if Y-axis is regarded as the brightness of the video signal input according to time. FIG. 4A shows the brightness of the unprocessed current frame Iₙ, and FIG. 4B shows the brightness of the smoothing frame Iₛ that underwent a smoothing process in the smoothing module 110. As shown therein, the brightness of the current frame, which alternates between increasing and decreasing, is smoothed while undergoing the smoothing process of the smoothing module 110.

The smoothing module 110 may output the sub-frame B₁ of FIG. 3B, or the sub-frame B₂ of FIG. 3C to the frame synthesizer 130. The sub-frame B₂ of FIG. 3C is obtained by subtracting difference in brightness between the video signals corresponding to boundaries of the image blocks from the sub-frame B₁ of FIG. 3B. That is, the smoothing module 110 adjusts the difference in the brightness between the image blocks to be gentle and thus smoothes the boundary between the image blocks. Like this, if the clear boundary of the image block becomes smoothed, the input video signal is prevented from a blocking phenomenon and a motion picture becomes more natural. Here, the smoothing module 110 may set up the brightness of the video signals corresponding to the boundaries of the image blocks as an average-brightness between the neighboring video signals. For example, suppose that the image block having an average brightness of “10” is neighboring the image block having an average brightness of “100.” Here, the brightness of the video signal has a pattern of “10 10 10 100 100 100.” In this case, if the brightness has a pattern “10 10 10”, the average brightness is “10.” If the brightness has a pattern of “10 10 100”, the average brightness is “40.” If the brightness has a pattern of “10 100 100,” the average brightness is “70”. If the brightness has a pattern of “100 100 100,” the average brightness is “100.” That is, the brightness between the boundaries of two image blocks is changed not suddenly from “10” to “100” but smoothly in the form of“10 40 70 100.” This is an example of reducing the brightness difference between the video signals corresponding to the boundaries of the image blocks.

The motion determiner 120 determines a motion state in the current frame Iₙ, and generates the motion coefficient to adjust the brightness of the first sub-frame I₁ according to the motion state. Here, the motion state means not only whether a motion is generated in the current frame Iₙ but also a degree of a motion in the current frame Iₙ according to motion difference between the current frame Iₙ and the previous frame Iₙ₋₁. In the case where a motion picture is input, i.e., if the difference in the brightness of the video signal between the frames increases, the motion state increases. On the other hand, in the case where a still picture is input, the motion state decreases.

As an index of the motion state, the motion coefficient f(α) according to an embodiment of the present invention is as follows.

f(α)ₙ=f(α)ₙ₋₁+k <Expression 1>

where, f(α)ₙ is a motion coefficient of the current frame In, f(α)ₙ₋₁ is a motion coefficient of the previous frame Iₙ, and k is a constant.

k may be larger than 0 and smaller than 1, e.g., may range from 0.1 to 0.5, which can be adjusted by a user. Thus, a brightness change rate for the first sub-frame I₁ is adjusted depending on k. The motion coefficient f(α) is within a range between 0 and 1, and decreases as the motion state of the current frame Iₙ increases. That is, the motion coefficient f(α) is in inverse proportion to the motion state.

The motion determiner 120 determines whether a motion is in the current frame Iₙ by comparing the video signal of the current frame Iₙ with the video signal of the previous frame Iₙ₋₁, and performs an operation of adding or subtracting k according to whether the motion is in the current frame Iₙ. If the brightness of the current frame Iₙ is changed as compared with the previous frame Iₙ₋₁, the motion determiner 120 determines that there is a motion in the current frame Iₙ and subtracts k from the motion coefficient f(α)ₙ₋₁ of the previous frame Iₙ₋₁ [i.e., f(α)ₙ=f(α)ₙ₋₁−k]. On the other hand, if the brightness of the current frame Iₙ is equal to that of the previous frame Iₙ₋₁, the motion determiner 120 determines that there is no motion in the current frame Iₙ and adds k to the motion coefficient f(α)ₙ₋₁ of the previous frame Iₙ₋₁ [i.e., f(α)ₙ=f(α)ₙ₋₁+k]. If a still picture having no motion is successively input, the motion coefficient f(α) increases gradually. On the other hand, if a motion picture is successively input, the motion coefficient f(α) decreases gradually. Here, the motion determiner 120 may determine whether the motion is in the current frame Iₙ with regard to a full frame, a pixel, or a certain area. Further, the motion determiner 120 may determine the motion state on the basis of the next frame following the current frame Iₙ as well as the previous frame Iₙ₋₁ and current frame Iₙ. In addition, various known methods may be used to determine whether the motion exists and the degree of the motion.

The smoothing frame Iₛ generated in the smoothing module 110 and the motion coefficient f(α) calculated in the motion determiner 120 are input to the frame synthesizer 130. The frame synthesizer 130 synthesizes the motion coefficient f(α) and the smoothing frame Iₛ to form the first sub-frame I₁. The first sub-frame Iₛ is represented as f(α)ₙ*Iₛ. Because the motion coefficient f(α) decreases when the motion state of the current frame Iₙ increases, the brightness of the first sub-frame I₁ is also decreased gradually. On the other hand, because the motion coefficient f(α) increases when the motion state of the current frame Iₙ decreases, the brightness of the first sub-frame I₁ is also increased gradually. Since the motion coefficient f(α) is variable from 0 to 1, the brightness of the first sub-frame I₁ is variable from black to the brightness of the smoothing frameIₛ. FIG. 4C shows an example of the first sub-frame I₁, of which brightness is lower than that of the smoothing frame Iₛ shown in FIG. 4B.

The first sub-frame I₁ corresponds to an additional image conventionally inserted to get an impulsive-type driving effect. In the conventional case that the black image is inserted between the original image frames, the brightness of the image is suddenly lowered and thus the difference in the brightness between the neighboring frames becomes larger, thereby causing a flicker. However, according to this embodiment, when a motion picture of which the motion state increases gradually is input, the image of which brightness is gradually decreased is inserted as the first sub-frame I₁, thereby solving problems of an image blurring phenomenon and a residual image. On the other hand, when a still picture is input, the brightness of the first sub-frame I₁ is varied to approximate the brightness of the smoothing frame Iₛ. In this case, the difference in the brightness between the first sub-frame I₁ and the second sub-frame I₂ which is described later, is decreased so that a flicker due to the brightness difference between the neighboring frames can be reduced without lowering the brightness of an image. In brief, the signal controller 100 according to the present embodiment generates the first sub-frame I₁ and the second sub-frame I₂ each of which brightness is changed in consideration of a brightness change of an image, i.e., the degree of the motion. Since each brightness of the first and second sub-frames I₁ and I₂ is adjusted on the basis of the motion coefficients f(α) of the neighbor input frames and settable k, each brightness thereof can naturally increase or decrease without a sudden change.

The enhancive module 140 generates the second sub-frame I₂ to compensate the brightness of the first sub-frame I₁ on the basis of the current frame Iₙ and the first sub-frame I_{I}. The second sub-frame I₂ is a frame for compensating the brightness of the first sub-frame I₁. The enhancive module 140 doubles the brightness of the current frame Iₙ and then subtracts the brightness of the first sub-frame Iₙ from the doubled brightness of the current frame Iₙ. The second sub-frame I₂ may be represented by 2*Iₙ−I₁=2*Iₙ−f(α)ₙ*Iₛ or Iₙ+Iₙ−I₁). Here, “Inₙ−I₁” means that the brightness of the smoothing frame, of which a high-frequency component is removed, i.e., a low-frequency image is subtracted from the unprocessed current frame Iₙ, which consequently corresponds to a high-frequency image. The second sub-frame I₂, obtained by adding the high-frequency image (Iₙ−I₁) to the current frame Iₙ, may be received as an enhancive frame that emphasizes the high-frequency image in the input current frame Iₙ. FIG. 4D shows the brightness of the second sub-frame I₂, of which the high frequency is compensated in the current frame Iₙ of FIG. 4A. The enhancive module 140 may include a multiplier to double the brightness of the current frame Iₙ, and a subtractor to subtract the brightness of the first sub-frame I₁ from the doubled brightness of the current frame Iₙ.

Alternatively, gamma correction may be applied to each brightness of the first and second sub-frames I₁ and I₂. In the case where the gamma correction is performed to non-linearly code the input video signal, the brightness of the second sub-frame I₂ is represented by I₂=(Iₙ^{γ}+Iₙ^{γ}−I₁^{γ})^{1/γ}.

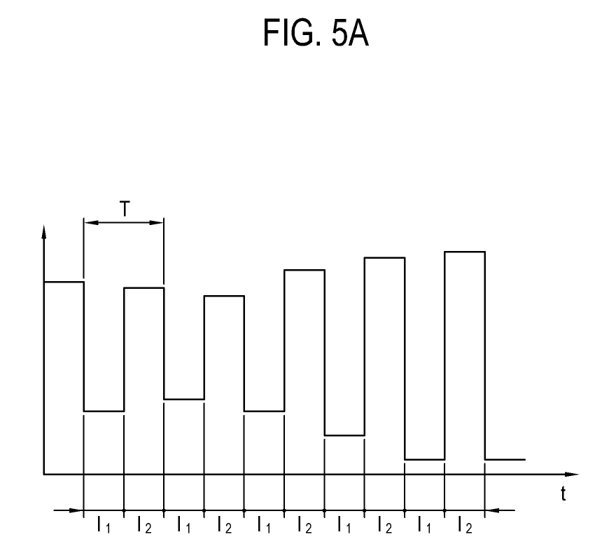

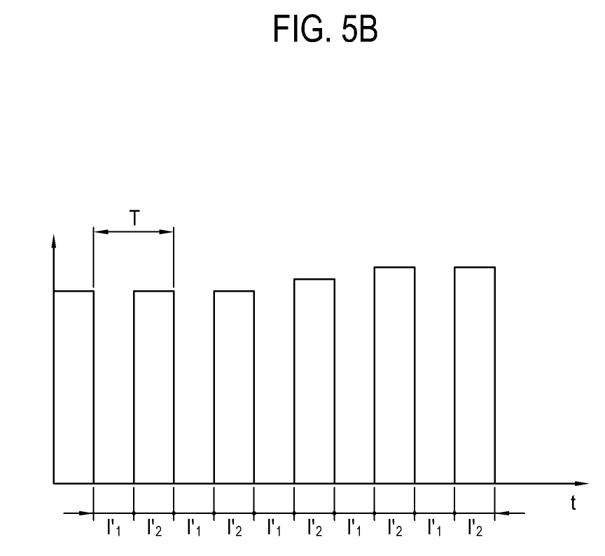

The first sub-frame I₁ and the second sub-frame I₂, generated through the foregoing processes, are displayed on the display unit 200 in sequence. FIGS. 5A and 5B are graphs for explaining an image processing effect according to the present embodiment. FIG. 5A shows the brightness of the first and second sub-frames I₁ and I₂ sequentially displayed on the display unit 200, and FIG. 5B shows the brightness obtained by inserting the conventional black image.

In the case that the conventional black image is inserted, the first sub-frame I₁′ corresponding to the black image and the second sub-frame I₂′ having brightness two times higher than that of an input original frame are successively displayed for a certain period T as shown in FIG. 5B. Because the difference in the brightness between the neighboring sub-frames I₁′ and I₂′ is two times higher than the brightness of the input original frame, the brightness difference causes the flicker and the black image having zero brightness lowers the brightness of an image. On the other hand, according to the present embodiment, the first sub-frame I₁, of which the high frequency is reduced and the motion state is considered, and the second sub-frame I₂, reinforced with the high frequency for compensating the brightness of the first sub-frame I₁, are displayed in sequence. As shown in FIG. 5A, the brightness of the first sub-frame I₁ increases gradually and decreases again, and correspondingly the brightness of the second sub-frame I₂ is also varied.

That the brightness of the first sub-frame I₁ increases gradually and the brightness difference from the second sub-frame I₂ is reduced means an input of a still picture. On the other hand, that the brightness of the first sub-frame I₁ decreases gradually and the brightness difference from the second sub-frame I₂ is enlarged means an input of a motion picture. According to the present embodiment, the brightness between the frames successively displayed is adjusted according to whether the input video signal contains a motion, so that a motion blur and a flicker are decreased.

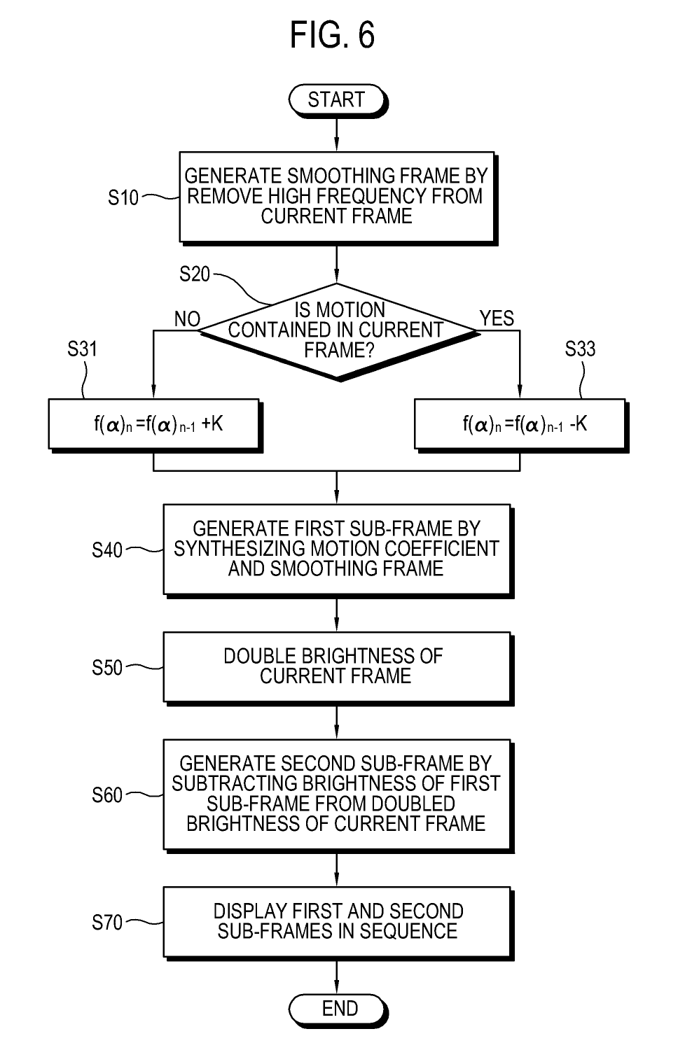

FIG. 6 is a flowchart of controlling the display apparatus according to the first embodiment. Below, an image processing method of the signal controller 100 will be described with reference to FIG. 6.

First, the smoothing module 110 generates the smoothing frame Iₛ by removing the high frequency from the current frame Iₙ (S10). Here, the smoothing module 110 may include a low-pass filter to remove the high frequency. Also, the smoothing module 110 may be achieved by various algorithms to generate the smoothing frame Iₛ having a certain brightness.

The motion determiner 120 determines whether the input current frame Iₙ contains a motion or not (S20). As a result, if the current frame Iₙ contains no motion, that is, if the current frame Iₙ has the same brightness as the previous frame Iₙ₋₁, the motion determiner 120 adds a constant k to the motion coefficient f(α)n-1 of the previous frame Iₙ₋₁ (S31). If the current frame Iₙ contains a motion, that is, if the current frame Iₙ is different in brightness from the previous frame Iₙ₋₁, the motion determiner 120 subtracts a constant k from the motion coefficient f(α)n-1 of the previous frame Iₙ₋₁ (S32).

The operations S20, S31, S32 of determining the motion in the current frame Iₙ and calculating the motion coefficient may be performed before or at the same time when the operation S10 of generating the smoothing frame Iₛ is performed. For convenience, the foregoing operations are described in sequence, but not limited thereto. In other words, the scope of the present invention is not limited to the sequence of the control operation.

Then, the frame synthesizer 130 synthesizes the motion coefficient f(α) and the smoothing frame Iₛ to generate the first sub-frame I₁ (S40). The more the motion state, the lower the brightness of the first sub-frame I₁. On the other hand, the less the motion state, the higher the brightness of the first sub-frame I₁.

The enhancive module 140 doubles the brightness of the current frame Iₙ (S50), and subtract the brightness of the first sub-frame I₁ from the doubled brightness of the current frame Iₙ (S60). Here, the second sub-frame corresponds to a video signal of which a high frequency component is emphasized to compensate the brightness of the first sub-frame I₁.

Then, the first sub-frame I₁ and the second sub-frame I₂ are output to and displayed on the display unit 200 in sequence, but the sequence of the sub-frame to be displayed is not limited thereto.

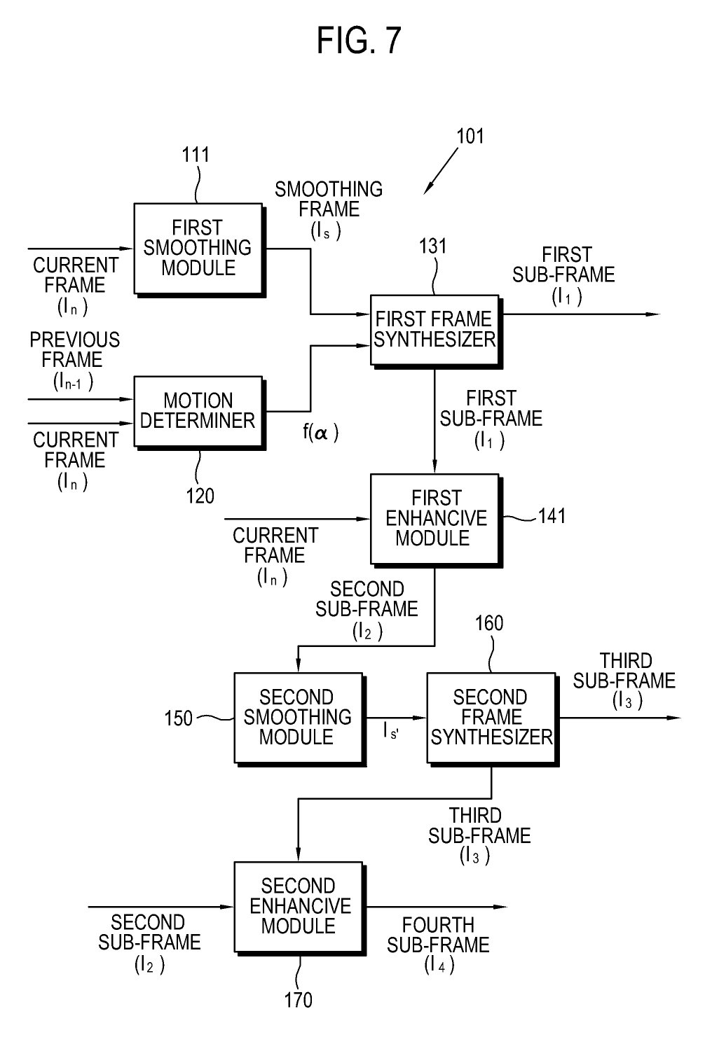

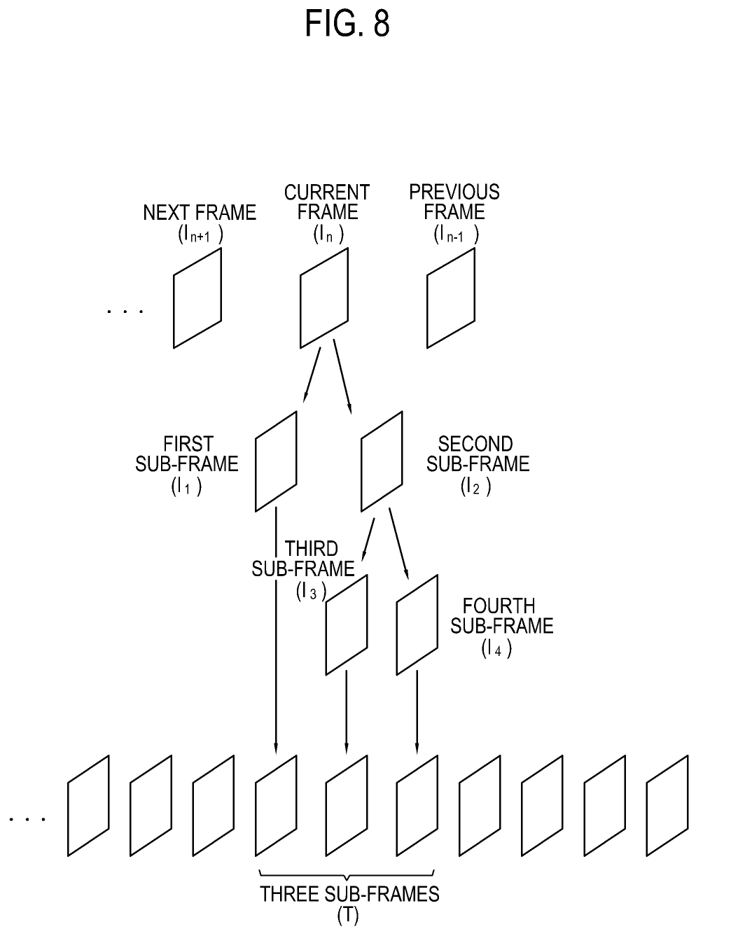

FIG. 7 is a control block diagram of a signal controller according to a second embodiment of the present invention, and FIG. 8 illustrates frames according to FIG. 7.

As shown therein, the signal controller 101 includes two smoothing modules 111, 150, two frame synthesizers 131, 160, and two enhancive modules 141, 170. A first smoothing module 111, a first frame synthesizer 131 and a first enhancive module 141 of the second embodiment are substantially equivalent to the smoothing module 110, the frame synthesizer 130 and the enhancive module 140 of FIG. 2. That is, the signal controller 101 according to the present embodiment is provided by duplicating the configuration of FIG. 2.

The second sub-frame I₂ is output from the first enhance module 141 to a second smoothing module 150, and undergoes substantially the same image process as the current frame Iₙ. A second smoothing module 150 generates an additional smoothing frame Iₛ′ to remove the high frequency of the second sub-frame I₂, and a second frame synthesizer 160 generates a third sub-frame I₃ on the basis of the motion coefficient f(α) and the additional smoothing frame Iₛ′.

Like that the first sub-frame I₁ is reinforced with the high frequency through the first enhancive module 140 and output as the second sub-frame I₂, the third sub-frame I₃ is also reinforced with the high frequency through the second enhancive module 170 and output as the fourth sub-frame I₄.

In brief, the first sub-frame I₁ and the third sub-frame I₃ correspond to the smoothing frame of which the high frequency is removed, and the second sub-frame I₂ and the fourth sub-frame I₄ correspond to the enhancive frame reinforced with the high frequency.

Such a plurality of sub-frames I₁, I₂, I₃ and Iₙ are selectively displayed on the display unit 200 as shown in FIG. 8. In this embodiment, the first sub-frame I₁, the third sub-frame I₂ and the fourth sub-frame I₃ are output for one period T. That is, total three frames are formed during the period T while one frame is conventionally displayed, so that the frame frequency increases three times. Among the plurality of sub-frames I₁, I₂, I₃ and Iₙ, how many sub-frames will be output, which sub-frames are output, in what sequence the sub-frames are output, etc. may be set variously. Here, an output ratio of the smoothing frame may be adjusted according to the degree of the motion in an image.

Further, the display apparatus may include not two but three or more smoothing modules and enhancive modules, and may repetitively process a video signal through a single smoothing module and a single enhancive module.

According to an embodiment of the present invention, a plurality of sub-frames are formed to reduce the image blurring phenomenon, the residual image and the flicker, caused when a motion picture is displayed in the hold-type display apparatus. The brightness of the sub-frame is naturally varied in consideration of the degree of the motion in the image, and there may be various methods to generate and output the sub-frames.

As described above, the present invention to provide a display apparatus and a control method of the same, in which a motion blur and a flicker are decreased.

Another aspect of the present invention is to provide a display apparatus and a control method thereof, in which the brightness of an image is enhanced.

Still another aspect of the present invention is to provide a display apparatus and a control method thereof, in which a blocking phenomenon in an input motion picture is removed to thereby improve picture quality.

Yet another aspect of the present invention is to provide a display apparatus capable of adjusting an additional image inserted according to a degree of a motion in an image, and a control method of the same.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising:
a display unit which displays an image; and
a signal controller which determines a motion state of a current frame based on a previous frame and the current frame input in sequence, generates a first sub-frame of which brightness is varied according to the motion state of the current frame, generates at least one second sub-frame to compensate the brightness of the first sub-frame based on the first sub-frame and the current frame, and outputs the first sub-frame and the second sub-frame in sequence, wherein the display unit displays the first and the second sub-frames in sequence.

2. The display apparatus according to claim 1, wherein the signal controller generates a motion coefficient representing the motion state of the current frame and a smoothing frame by removing a high frequency component from the current frame, and generates the first sub-frame by synthesizing the motion coefficient and the smoothing frame.

3. The display apparatus according to claim 2, wherein the motion coefficient has a value that ranges from 0 to 1, and becomes lower as the motion state of the current frame increases.

4. The display apparatus according to claim 3, wherein the signal controller determines whether the current frame contains a motion, and the motion coefficient of the current frame is set by subtracting a preset constant from the motion coefficient of the previous frame if the current frame contains the motion.

5. The display apparatus according to claim 3, wherein the signal controller determines whether the current frame contains a motion, and the motion coefficient of the current frame is set by adding a preset constant to the motion coefficient of the previous frame if the current frame does not contain the motion.

6. The display apparatus according to claim 2, wherein the smoothing frame comprises average brightness of the current frame.

7. The display apparatus according to claim 2, wherein the signal controller divides the current frame into a plurality of image blocks, and calculates average brightnesses of the plurality of image blocks, and the smoothing frame is formed based on the image block.

8. The display apparatus according to claim 7, wherein the signal controller reduces a difference in brightness between neighboring video signals corresponding to boundaries of two of the plurality of image blocks.

9. The display apparatus according to claim 8, wherein the signal controller reduces the difference in brightness by setting brightnesses corresponding to the boundaries of two of the plurality of the image block as average brightnesses of the neighboring video signals.

10. The display apparatus according to claim 7, wherein the signal controller removes a high-frequency image from boundaries of one of the plurality of image blocks.

11. The display apparatus according to claim 2, wherein a brightness of the second sub-frame corresponds a value obtained by subtracting the brightness of the first sub-frame from a doubled brightness of the current frame.

12. The display apparatus according to claim 11, wherein the signal controller generates an additional smoothing frame based on the second sub-frame, and generates a third sub-frame based on the additional smoothing frame and the motion coefficient.

13. The display apparatus according to claim 12, wherein the signal controller generates a fourth sub-frame corresponding to a value obtained by subtracting the brightness of the first sub-frame from a doubled brightness of the third sub-frame.

14. The display apparatus according to claim 13, wherein the signal controller displays at least two sub-frames from among the first, the second, the third and the fourth sub-frames for a preset period of time in sequence.

15. The display apparatus according to claim 1, wherein the display unit comprises a liquid crystal panel or an organic light emitting display panel.

16. A method of controlling a display apparatus comprising:
determining a motion state of a current frame based on a previous frame and the current frame input in sequence;
generating a first sub-frame of which brightness is varied according to the motion state of the current frame;
generating at least one second sub-frame to compensate the brightness of the first sub-frame based on the first sub-frame and the current frame;
outputting the first sub-frame and the second sub-frame in sequence; and
displaying the first and the second sub-frames in sequence.

17. The method according to claim 16, wherein the determining the motion state comprises:
determining whether the current frame contains a motion; and
calculating a motion coefficient that represents the motion state of the current frame.

18. The method according to claim 17, wherein the motion coefficient has a value that ranges from 0 to 1, and becomes lower as the motion state of the current frame increases.

19. The method according to claim 18, wherein the motion coefficient of the current frame is set by subtracting a preset constant from the motion coefficient of the previous frame if the current frame contains a motion.

20. The method according to claim 18, wherein the motion coefficient of the current frame is set by adding a preset constant to the motion coefficient of the previous frame if the current frame contains no motion.

21. The method according to claim 18, wherein the generating the first sub-frame comprises:
generating a smoothing frame by removing a high frequency component from the current frame; and
synthesizing the motion coefficient and the smoothing frame.

22. The method according to claim 21, wherein the generating the smoothing frame comprises:
dividing the current frame into a plurality of image blocks; and
calculating average brightnesses of the plurality of image blocks.

23. The method according to claim 22, wherein the generating the first sub-frame comprises: reducing a difference in brightness between neighboring video signals corresponding to boundaries of two of the plurality of image blocks.

24. The method according to claim 16, wherein the generating the second sub-frame comprises:
doubling a brightness of the current frame; and
subtracting the brightness of the first sub-frame from the doubled brightness of the current frame.
